(19) United States
(12) Patent Application Publication
(10) Pub. No.: US 2005/0022570 A1
(43) Pub. Date: Feb. 3, 2005

(54) Conditioner-fertilizer composition for modifying and improving the structure of saline soils and/or alkaline soils

(76) Inventor: Adalberto-Enrique Duarte-MacDonald, Cd. Camargo (MX)

Correspondence Address: ROTHWELL, FIGG, ERNST & MANBECK, P.C., 1425 K STREET, N.W., SUITE 800, WASHINGTON, DC, 20005, US

(21) Appl. No.: 10/901,061

(22) Filed: Jul. 29, 2004

(30) Foreign Application Priority Data
Jul. 29, 2003 (MX) PA/A/2003/006741

(51) Int. Cl. C05D 1/00

(52) U.S. Cl. 71/33

(57) ABSTRACT

An effective conditioner-fertilizer of low and competitive cost particularly formulated for restoring or improving the cultivation properties and productivity of saline or alkaline soils, comprising: a) a chelating substance, for example sodium tripolyphosphate; b) a pH modifying or buffering substance, for example an inorganic acid; c) a surfactant, for example polyethylenglycols; and optionally, d) a plant nutrient substance, for example humic extracts which can advantageously derived from the pecan husk. The synergistic combination of polyphosphates, pH modifying and buffering substances and surfactants in the conditioner-fertilizer formulation significantly improves its effectiveness at a competitive cost. Other ingredients may also be added, for example, sodium lignosulphonate, calcium lignosulphonate and the like for modifying the physical structure of soils. The conditioner-fertilizer can be applied directly to the soil before plantation, mixed with the irrigation water or to the leaves during plant growth.

### FIELD OF THE INVENTION

The present invention relates to a chemical composition of a conditioner-fertilizer specially formulated for modifying and improving saline soils or alkaline soils and therefore for improving their agricultural productivity.

### BACKGROUND OF THE INVENTION

In many agricultural regions the problem of low yield in crops or of sub-normal crops growth is due to the saline or alkaline, nature of the soil, or because soils gradually concentrate salinity under drought conditions, when water loss occurs by evaporation or transpiration and not through percolation thus favoring salts concentration in soils; this also occurs when irrigation water is saline.

Normal fertilizers are formulated on the basis of crops nutrient needs and generally comprise mineral elements and organic elements needed by plants and become exhausted as the same crop are repeated.

New formulations are needed for saline or alkaline soils which have lost their cultivation properties and which also require nutrients as well as PH stabilizers. These new formulations also should contribute to restore or to provide appropriate cultivation characteristics.

British patent specification No. 803,052 describes a composition for improving soils. The object of the invention of this patent is to make available to plants metals which are present in the soil but which in such a condition that said metals are not utilizable by the plants. The soils may have high alkalinity or lime content, or phosphate content. The composition disclosed by this patent comprises chelates and chelating agents but is mainly addressed to correct iron deficiency. The chelating agent is a carboxylated amine. This patent however does not suggest the synergistic combination of a chelating agent, a pH buffer and a surfactant as claimed in the present invention.

U.S. Pat. No. 4,588,431 discloses a phosphatic fertilizer comprising humic acid for turning the alkaline ingredients of fused phosphates into chelate compounds. This patent however does not suggest the synergistic combination of a chelating agent, a pH buffer and a surfactant as claimed in the present invention.

U.S. Pat. No. 5,514,200 discloses a concentrated phosphorus fertilizer comprising a buffered composition of an organic acid and salts thereof. This patent however does not address the problem of the alkaline soils neither does it suggest the synergistic combination of a chelating agent, a pH buffer and a surfactant as claimed in the present invention.

U.S. Pat. No. 5,698,001 discloses a soil additive including lignosulphonate, humic acid, an inert filler and a metal salt. This patent however does not address the problem of the alkaline soils neither does it suggest the synergistic combination of a chelating agent, a pH buffer and a surfactant as claimed in the present invention.

International patent application WO 02/059063 A1 discloses a fertilizer composition for saline or alkaline soils. The fertilizer composition of this patent application is liquid and provides a corrective and structural action on the soils, said composition comprising a calcium salt and a magnesium salt and an organic substance selected from the group of (1) a soil structuring agent, which can be lignin and its derivatives, soluble humates or humic extracts, anionic polyacrylamide, PVA and polymers of urea-formaldehyde (2) a chelating acidifying substance, which can be a carboxylic acid, for example: citric acid, tartaric acid, glutaric acids, trihydroxyglutaric acid, succinic acid and lactic acid and their salts with calcium, magnesium, potassium, ammonium, iron and zinc; (3) a nutrient medium or pabulum and their mixtures, comprising monosaccharides, disaccharides, polysaccharides and preferably glucose, fructose, cellulose, starch and amylopectin. The fertilizer disclosed in this patent publication however does not contain any pH modifying element which also acts as a buffering substance for stabilizing the acidity-alkalinity of soils, for example, inorganic acids, carbonates or polyphosphates. Neither does this prior art fertilizer composition contain any surfactant which helps water and other applied substances to penetrate in the soils, as for example, polyethylenglycols, tert-octylphenol etoxylates, sodium dodecylsulphate or sodium laurylsulphate.

There is therefore the need of an effective fertilizer which restores the cultivation properties to saline soils or alkaline soils or which improves said properties, and which can be easily applied at a competitive cost.

### SUMMARY OF THE INVENTION

The present invention provides a conditioner-fertilizer particularly useful for saline or alkaline soils, which is improved as compared with prior art fertilizers and which is effective and easily applied.

It is therefore an object of the invention to provide an improved, effective and cost-competitive conditioner-fertilizer for application in saline or alkaline soils in order to improve their cultivation properties and their productivity.

It is another object of the present invention to provide a method for regenerating saline or alkaline soils.

Other objects of the invention will be in part evident and in part pointed out hereinafter.

The objects of the present invention are generally achieved by applying to saline or alkaline soils a chemical composition containing:
(a) a chelating-substance
(b) a PH modifying or buffering substance;
(c) a surfactant substance; and optionally
(d) a plant nutrient substance.

### DETAILED DESCRIPTION OF THE INVENTION

In a preferred embodiment of the invention, a conditioner-fertilizer is prepared by mixing in liquid phase the following substances in the proportions set forth below:

(a) From about 10% to about 46%, preferably from about 15% to about 35%, and more preferably from about 20% to about 30% by weight of a chelating substance, for example: polyphosphates, namely sodium tripolyphosphate, sodium hexametaphosphate, as well as their mixtures. Polyphosphates have the property of chelation and therefore they chelate calcium and magnesium and other positive elements found in soils but presenting a higher affinity for calcium and magnesium.

Sodium tripolyphosphate has the following chelating capacity: 270 mg of Ca++ per gram of tripolyphosphate, 71 mg of Mg++ per gram of sodium tripolyphosphate, 71 mg of Zn++ per gram of sodium tripolyphosphate, 10 mg of Cu++ per gram of sodium tripolyphosphate, 250 mg of Fe++ per gram of sodium tripolyphosphate. (Source: Chemical Products Rhodia, manufacturers of phosphates). Another important property of polyphosphates is the inhibiting effect on the formation of crystals (The threshold Scale Inhibition Effect). Polyphosphate is absorbed on the surface of crystals, thus altering the pattern and velocity of crystal formation causing a crystal deformation and therefore, preventing crystal growth. These properties of polyphosphates (chelating agents) have not been used in agriculture and contribute to the novelty of the present invention.

Polyphosphates also have the property of acting as dispersants and therefore they disperse the crystals of salts and the soil particles. Polyphosphates have negative charges and thereby these have the ability of dispersing and maintaining in suspension particles in an aqueous medium. These negative charges allow for these polyphosphates being adsorbed in the surface of particles creating strong repulsion effects among particles. The dispersing character of polyphosphates and their use in agriculture is one of the novel bases of the invention because when applied in suitable dosages along with the irrigation water, a convenient dispersion of the salt crystals and of the particles present in soils is achieved, without damaging effects on crops. With this measure, the soil compaction is prevented and a good flow of water is favored among the soil particles. In case sodium is in excessive quantities in soils, the effect of tripolyphosphates produces a wash thereof (lixiviation or leaching), which benefits soils since an excess of sodium causes problems of low soil permeability.

The chelating agents to be utilized according to the invention will depend on the content of salts in the saline soil.

b) From about 1% to about 20%, preferably from about 3% to about 15%, and more preferably from about 3.5% to about 10% by weight, of a buffering or pH modifying substance, which will be added according to the value of pH of the soil, the pH of the saline solution present in the soil, or the value of pH of the irrigation water. Some examples of the pH modifying or buffering substances are: inorganic acids, lime, calcium carbonate, and mixtures thereof.

c) From about 0.03% to about 0.5%, more preferably from about 0.04% to about 0.3%, and more preferably from about 0.07% to about 0.15% by weight, of a surfactant. Examples of usable surfactants for the present invention are: polyethyleneglycols, tert-octylphenol ethoxylates, tert-nonylphenol ethoxylates, primary alcohols having 16 to 20 carbon atoms, sodium dodecylsulphate, sodium laurylsulphate, and mixtures thereof.

d) Optionally, from about 10% to about 40% by weight of one or more plants nutrients, for example, humic extracts derived from the bacteriological degradation of pecan husk of the american pecan tree. The pecan fruit comprises pericarpium, mesocarpium and the seed (The mesocarpium (husk) portion has the following approximate composition: nitrogen from 0.3% to 0.7%; phosphorous from 0.05% to 0.15%; potassium from 3.0% to 5.0%; calcium from 0.2% to 0.4%; magnesium from 0.1% to 0.3% and tannins from 30% to 60%). Other examples of nutrients are urea, potassium citrate, potassium nitrate, potassium chloride and mixtures thereof.

Other ingredients may be added to the claimed composition for modifying the physical structure of soils, for example lignin and its derivatives, lignosulphonates, for example, sodium, calcium and potassium lignosulphonates. These ingredients may be added in variable proportions supplementing the above-mentioned essential components of the fertilizer subject of this application.

After preparing the liquid solution of the above-mentioned ingredients, a suitable amount thereof, according to the degree of soil salinity or alkalinity, may be applied to the leaves during the plant growth, or directly to the soil before planting, or may also be mixed with the irrigation Water. Preferably, the solution is applied in doses of about 3 to about 40 liters per ha when applied to the soil. When applied to the leaves, dosages may vary between about 1 to about 5 liters per ha. When applied by irrigation, dosages may vary from a minimum of about 3 liters to about 100 liters per ha, depending on the type of crop, type of soil, soil requirements and of the intensity of irrigation. The present conditioner-fertilizer may also, if so desired, be diluted for proportional application through micro-irrigation systems.

Incorporation of dispersing agents, surfactants and buffers, to the conditioner-fertilizer, according to the invention, significantly contributes to the effectiveness thereof. Surfactants are materials which decrease the surface tension of solutions, and thus help penetration into soil of water and the chemical components of the fertilizer. In this way, the efficacy of the fertilizer increases since the physico-chemical effect on the soil is favored. The pH buffering and modifying ingredients contribute to maintaining an adequate acidity-alkalinity condition in the soil for a longer time and avoid formation of zones having an extreme acidity as is the case when only acids are applied to soil for neutralizing its alkalinity.

The following examples are herein included merely as an illustration of the present invention and are not intended to limit the embodiments thereof in the many possibilities of application or combination of the constituents of the invention.

### EXAMPLE 1

A preferred composition of the claimed invention is as follows:

| 30 Kg of sodium tripolyphosphate = | 25.00% by weight |
|---|---|
| 5 Kg of sulfuric acid = | 4.17% |
| 12 Kg of potassium nitrate = | 10.00% |
| 2.5 Kg of humic extracts = | 1.92% |
| 0.15 Kg of sodium lauryl sulphate = | 0.13% |
| 20 Kg of urea = | 16.67% |

The above-mentioned materials are dissolved in about 60 liters of water and thereafter more water is added to complete 100 liters of solution. (The percentage indicated has been calculated for the total mixture including water).

### EXAMPLE 2

| 30 Kg of sodium tripolyphosphate = | 25.00% by weight |
|---|---|
| 6 Kg of sulfuric acid = | 5.00% |
| 0.10 Kg of sodium lauryl sulphate = | 0.08% |

The above-mentioned materials are dissolved in about 60 liters of water and thereafter more water is added to complete 100 liters of solution. (The percentage indicated has been calculated for the total mixture including water).

### EXAMPLE 3

| 20 Kg of sodium tripolyphosphate = | 16.67% by weight |
|---|---|
| 5 Kg of phosphoric acid = | 4.17% |
| 10 Kg of potassium citrate = | 8.33% |
| 18 Kg of humic extracts = | 15.00% |
| 0.15 Kg of sodium lauryl sulphate = | 0.13% |

The above-mentioned materials are dissolved in about 60 liters of water and thereafter more water is added to complete 100 liters of solution. (The percentage indicated has been calculated for the total mixture including water).

### EXAMPLE 4

| 2 Kg of phosphoric acid = | 1.67% by weight |
|---|---|
| 18 Kg of humic extracts = | 15.00% |
| 10 Kg of potassium citrate = | 8.33% |
| 20 Kg of sodium tripolyphosphate = | 16.67% |
| 0.3 Kg of sodium dodecylsulphate = | 0.25% |

The above-mentioned materials are dissolved in about 60 liters of water and thereafter more water is added to complete 100 liters of solution. (The percentage indicated has been calculated for the total mixture including water).

### EXAMPLE 5

| 2 Kg of sulfuric acid = | 1.67% by weight |
|---|---|
| 15 Kg of humic extracts = | 12.50% |
| 17 Kg of potassium chloride = | 14.17% |
| 30 Kg of potassium tripolyphosphate = | 25.00% |
| 0.2 Kg of sodium lauryl sulphate = | 0.17% |

The above-mentioned materials are dissolved in about 60 liters of water and thereafter more water is added to complete 100 liters of solution. (The percentage indicated has been calculated for the total mixture including water).

### EXAMPLE 6

| 30 Kg of calcium tripolyphosphate = | 25.00% by weight |
|---|---|
| 5 Kg of sulfuric acid = | 4.17% |
| 12 Kg of potassium nitrate = | 10.00% |
| 15 Kg of humic extracts = | 12.50% |
| 0.15 Kg of sodium lauryl sulphate = | 0.13% |

The above-mentioned materials are dissolved in about 60 liters of water and thereafter more water is added to complete 100 liters of solution. (The percentage indicated has been calculated for the total mixture including water).

### EXAMPLE 7

| 6 Kg of sulfuric acid = | 5.00% by weight |
|---|---|
| 20 Kg of urea = | 16.67% |
| 40 Kg of sodium tripolyphosphate = | 25.00% |
| 0.10 Kg of sodium lauryl sulphate = | 0.08% |

The above-mentioned materials are dissolved in about 60 liters of water and thereafter more water is added to complete 100 liters of solution. (The percentage indicated has been calculated for the total mixture including water).

### EXAMPLE 8

| 2 Kg of phosphoric acid = | 1.54% by weight |
|---|---|
| 8 Kg of humic extracts = | 6.15% |
| 3 Kg of potassium citrate = | 2.30% |
| 3 Kg of sodium lignosulphonate = | 2.30% |
| 1 Kg of sodium dodecylsulfate = | 0.77% |

The above-mentioned materials are dissolved in about 60 liters of water and thereafter more water is added to complete 100 liters of solution. (The percentage indicated has been calculated for the total mixture including water).

### EXAMPLE 9

| 3 Kg of sodium lignosulphonate = | 2.30% by weight |
|---|---|
| 2 Kg of sulfuric acid = | 1.54% |
| 5 Kg of potassium chloride = | 3.85% |
| 3 Kg of humic extracts = | 2.30% |
| 1 Kg of sodium lauryl sulfate = | 0.77% |

The above-mentioned materials are dissolved in about 60 liters of water and thereafter more water is added to complete 100 liters of solution. (The percentage indicated has been calculated for the total mixture including water).

### EXAMPLE 10

| | |
|---|---|
| 8 Kg of sodium tripolyphosphate = | 6.15% |
| 12 Kg of potassium nitrate = | 9.23% |
| 15 Kg of humic extracts = | 11.53% |
| 5 Kg of sulfuric acid = | 3.85% |
| 1 Kg of sodium lauryl sulfate = | 0.77% |

The above-mentioned materials are dissolved in about 60 liters of water and thereafter more water is added to complete 100 liters of solution. (The percentage indicated has been calculated for the total mixture including water).

### EXAMPLE 11

| | |
|---|---|
| 10 Kg of sodium tripolyphosphate = | 8.33% |
| 5 Kg of sodium lignosulphonate = | 4.17% |
| 5 Kg of sulfuric acid = | 4.17% |
| 1 Kg of sodium lauryl sulfate = | 0.83% |

The above-mentioned materials are dissolved in about 60 liters of water and thereafter more water is added to complete 100 liters of solution. (The percentage indicated has been calculated for the total mixture including water).

Experimental Results.

The conditioner-fertilizer of the invention was tested under a statistically-controlled test program in order to determine its effectiveness with actual measurements of soil parameters after its application. The composition of Example I was used in the test program.

Random samples of soil were selected and placed in 20 buckets of 20 liter capacity. Three treatments with applications of 10, 20 and 60 liters/ha and a control were set up, and 5 repetitions for each one were made.

One application was made saturating the experimental units with and without treatment, and after 8 days the samples were analyzed in a laboratory.

The samples were analyzed following the Modified Olsen methodology for determination of phosphorus, potassium, copper, iron, manganese and zinc. For determination of calcium and magnesium, an extracting solution of KCl 1 N was utilized. For determination of sodium a saturation extract was utilized. For other parameters, the methods described in Rodriguez Fuentes, H and Rodriguez Absi, J.; Methods of Analysis of soils and plants. Interpretation Criteria. Ed. Trillas, Mexico, were followed.

Conclusions:

1. Advantages of applying the fertilizer-conditioner on the physicochemical structure of soil:
Does not affect the organic matter.
There is less potential salinity for seeds, plants and microorganisms.
There is less potential of nutrients loss by lixiviation.

2. The following results were obtained from the evaluation of the test program:
An increase in availability of minerals and nutrients in utilizable form for plants.
An increase in good chemical activity, promoting a higher capacity of soil nutrients exchange.
An adjustment of soil pH.
An increase in availability of P, K and Zn.

In general, the nutrient richness of soils is enhanced thereby permitting a decrease of fertilizer costs.

TABLE 1
Typical values of main parameters of soils

| | | Accept- | | | |
|---|---|---|---|---|---|
| | Low | able | Optimum | High | Very high |
| pH | | | <7.0 | | |
| Soluble Salts | 0-0.74 | 0.75-1.99 | 2-3.49 | 3.5-5 | >5 |
| (mohm/ | | | | | |
| cm25° C.) | | | | | |
| N-NO (mg/l) | 0-39 | 40-99 | 100-199 | 200-299 | >300 |
| Phosphorus | 0-2 | 3-5 | 6-10 | 11-18 | >19 |
| (mg/l) | | | | | |
| Potassium | 0-59 | 60-149 | 150-249 | 250-349 | >350 |
| (mg/l) | | | | | |
| Calcium | 0-79 | 80-199 | >200 | | |
| (mg/l) | | | | | |
| Magnesium | 0-29 | 30-69 | >70 | | |
| (mg/l) | | | | | |

The desired normal levels of nutrients based on the content of soluble salts are: for N—NO3=8%; for potassium=12%; for calcium=15% and for magnesium=5%. Percentage of chlorides and sodium should be less than 10%.

The values of the minerals concentration each sample evaluated in the test are shown in Table 2 below:

TABLE 2
Units: ppm (parts per million)

| | P | K | Ca | Mg | Cu | Zn | Fe | Mn | Na |
|---|---|---|---|---|---|---|---|---|---|
| TR1 | 9.51 | 31.78 | 1605.6 | 358 | 0.47 | 3.50 | 5.32 | 2.08 | 2415.4 |
| TR2 | 11.57 | 28.21 | 1988.4 | 346 | 0.36 | 3.28 | 5.22 | 1.50 | 1161.5 |
| TR3 | 9.07 | 27.25 | 2023.2 | 317 | 0.46 | 3.43 | 3.92 | 1.33 | 957.20 |
| TR4 | 9.51 | 26.37 | | | 0.31 | 3.71 | 3.53 | 1.03 | 874.80 |
| TR5 | 11.42 | 29.27 | | | 0.37 | 3.39 | 6.23 | 1.46 | 795.10 |
| 10R1 | 519.82 | 489.85 | 1512.8 | 219 | 0.40 | 8.25 | 7.65 | 1.76 | 1766.60 |
| 10R2 | 578.56 | 476.60 | 1442.2 | 229 | 0.42 | 8.21 | 8.81 | 1.98 | 1891.5 |
| 10R3 | 563.87 | 463.05 | 1608.6 | 258 | 0.36 | 7.50 | 11.97 | 2.34 | 1991.10 |
| 10R4 | 541.85 | 483.15 | | | 0.38 | 7.76 | 7.91 | 1.99 | 2090.70 |
| 10R5 | 578.56 | 470.85 | | | 0.43 | 8.32 | 8.19 | 2.23 | 2097.10 |
| 20R1 | 527.16 | 457.90 | 1602.6 | 267 | 0.38 | 7.00 | 7.25 | 1.99 | 1633.00 |
| 20R2 | 585.90 | 450.50 | 1661.6 | 291 | 0.36 | 8.29 | 7.29 | 2.02 | 1865.60 |
| 20R3 | 578.56 | 426.85 | 1475.4 | 343 | 0.39 | 8.38 | 7.30 | 2.26 | 1887.30 |
| 20R4 | 607.93 | 453.70 | | | 0.45 | 8.48 | 8.46 | 2.92 | 1996.30 |
| 20R5 | 571.22 | 448.45 | | | 0.52 | 7.90 | 6.96 | 2.34 | 1677.90 |
| 60R1 | 1569.75 | 1381.00 | 838.6 | 100 | 0.56 | 108.05 | 20.66 | 7.07 | 5107.00 |
| 60R2 | 1511.01 | 1284.35 | 830.6 | 102 | 0.51 | 101.70 | 14.58 | 6.49 | 571.00 |
| 60R3 | 1555.06 | 1379.35 | 797.0 | 110 | 0.60 | 103.35 | 15.40 | 6.64 | 481.00 |
| 60R4 | 1584.43 | 1366.70 | | | 0.64 | 102.00 | 13.24 | 6.40 | 1265.00 |
| 60R5 | 1342.14 | 1160.75 | | | 0.50 | 84.70 | 11.85 | 5.62 | 763.00 |

(TRi = control without conditioner-fertilizer application;
10Ri = Application of 10 liters/ha
20Ri = Application of 20 liters/ha
60Ri = Application of 60 liters/ha)

TABLE 3
Values of other parameters of samples of soil

| | | | Electrical |
|---|---|---|---|
| | | | Conductivity |
| | % Organic Matter | pH | mS/cm at 25° C. |
| TR1 | 0.26 | 8.0 | 2.63 |
| TR2 | 0.23 | 8.0 | 2.42 |
| TR3 | 0.20 | 8.0 | 2.32 |
| TR4 | 0.23 | 8.0 | 2.16 |
| TR5 | 0.26 | 8.0 | 2.36 |
| 10R1 | 0.26 | 7.9 | 9.86 |
| 10R2 | 0.26 | 8.0 | 9.96 |
| 10R3 | 0.20 | 8.0 | 10.54 |
| 10R4 | 0.26 | 7.8 | 10.72 |
| 10R5 | 0.26 | 8.0 | 10.39 |
| 20R1 | 0.29 | 8.0 | 8.66 |
| 20R2 | 0.29 | 7.8 | 9.08 |
| 20R3 | 0.26 | 7.8 | 10.46 |
| 20R4 | 0.29 | 7.9 | 10.61 |
| 20R5 | 0.26 | 7.9 | 10.09 |
| 60R1 | 0.23 | 7.4 | 21.30 |
| 60R2 | 0.20 | 7.4 | 22.40 |
| 60R3 | 0.26 | 7.4 | 21.70 |
| 60R4 | 0.20 | 7.4 | 21.10 |
| 60R5 | 0.26 | 7.5 | 20.00 |

TABLE 4
Analysis and classification of the samples of soil

| | % Sand | % Limo | % Clay | Soil Classification |
|---|---|---|---|---|
| TR1 | 23.64 | 34.36 | 42.00 | Clay |
| TR2 | 18.00 | 41.28 | 40.72 | Limous clay |
| TR3 | 22.36 | 37.64 | 40.00 | Clay |
| TR4 | 20.36 | 39.28 | 40.36 | Clay |
| TR5 | 17.64 | 41.64 | 40.72 | Limous Clay |
| 10R1 | 19.64 | 34.36 | 46.00 | Clay |
| 10R2 | 20.72 | 39.28 | 40.00 | Clay |
| 10R3 | 19.64 | 37.64 | 42.72 | Clay |
| 10R4 | 21.28 | 36.00 | 42.72 | Clay |
| 10R5 | 21.64 | 35.64 | 42.72 | Clay |
| 20R1 | 18.36 | 41.64 | 40.00 | Limous Clay |
| 20R2 | 22.00 | 35.64 | 42.36 | Clay |
| 20R3 | 22.36 | 37.28 | 40.36 | Clay |
| 20R4 | 18.36 | 39.28 | 42.36 | Clay |
| 20R5 | 18.36 | 38.00 | 43.64 | Clay |
| 60R1 | 17.64 | 36.36 | 46.00 | Clay |
| 60R2 | 17.64 | 39.64 | 42.72 | Clay |
| 60R3 | 18.36 | 38.00 | 43.64 | Clay |
| 60R4 | 17.64 | 37.64 | 44.72 | Clay |
| 60R5 | 18.36 | 37.28 | 44.36 | Clay |

The above referenced study evidenced the advantages and benefits of the claimed conditioner-fertilizer particularly useful in alkaline and/or saline soils.

It is to be understood that the invention has been described in detail in this specification with reference to some preferred embodiments, but that the invention is not limited by said embodiments herein described and that numerous changes, variations, substitutions or equivalent mixtures may be made, without departing from the spirit and scope of the invention, which is defined and limited only by the scope of the attached claims.

1. A soil conditioner-fertilizer composition for saline or alkaline soils having salts of sodium, calcium or magnesium, which composition comprises:
a) a substance with chelating properties;
b) a substance for buffering or modifying pH; and
c) a surfactant.

2. A soil conditioner-fertilizer composition according to claim 1, wherein said substance with chelating properties is a polyphosphate.

3. A soil conditioner-fertilizer composition according to claim 2, wherein said polyphosphate is sodium tripolyphosphate, sodium hexamethaphosphate or mixtures thereof.

4. A soil conditioner-fertilizer composition according to claim 1, wherein said pH modifying or buffering substance are inorganic acids, lime, calcium carbonate, or mixtures thereof.

5. A soil conditioner-fertilizer composition according to claim 1, wherein said surfactant is polyethyleneglycol, tert-octylphenol ethoxylate, tert-nonylphenol ethoxylate, a primary alcohol having 16 to 20 carbon atoms, sodium dodecylsulphate, sodium lauryl-sulphate, or mixtures thereof.

6. A soil conditioner-fertilizer composition according to claim 1, further comprising a substance which is a nutrient for plants.

7. A soil conditioner-fertilizer composition according to claim 6, wherein said nutrient substance is at least one of humic extracts, urea, potassium citrate, potassium nitrate, potassium chloride, or mixtures thereof.

8. A soil conditioner-fertilizer composition according to claim 7, wherein said humic extract is derived from the pecan husk.

9. A soil conditioner-fertilizer composition according to claim 1, further comprising a substance for modifying the physical structure of soils.

10. A soil conditioner-fertilizer composition according to claim 9, wherein said substance for modifying the physical structure of soils is a lignosulphonate.

11. A soil conditioner-fertilizer composition according to claim 10, wherein said lignosulphonate is calcium lignosulphonate, sodium lignosulphonate, potassium lignosulphonate or mixtures thereof.

12. A soil conditioner-fertilizer composition for saline or alkaline soils having salts of sodium, calcium or magnesium, which composition comprises:
a) from about 10% to about 40% by weight a substance with chelating properties;
b) from about 1% to about 20% by weight, of a substance for buffering or modifying pH; and
c) from about 0.03% to about 0.5% by weight, of a surfactant.

13. A soil conditioner-fertilizer composition for saline or alkaline soils having salts of sodium, calcium or magnesium, which composition comprises:
a) from about 15% to about 35% by weight a substance with chelating properties;
b) from about 3% to about 15% by weight, of a substance for buffering or modifying pH; and
c) from about 0.04% to about 0.3% by weight, of a surfactant.

14. A soil conditioner-fertilizer composition for saline or alkaline soils having salts of sodium, calcium or magnesium, which composition comprises:
a) from about 20% to about 30% by weight a substance with chelating properties;
b) from about 3.5% to about 10% by weight, of a substance for buffering or modifying pH; and
c) from about 0.07% to about 0.15% by weight, of a surfactant.

15. A soil conditioner-fertilizer composition according to claim 12, further comprising a plant nutrient substance.

16. A soil conditioner-fertilizer composition according to claim 12, further comprising water wherein said substances are dissolved in a liquid phase.

17. A soil conditioner-fertilizer composition according to any of the preceding claim 16, wherein said substances are dissolved in about 100 liters of water for preparing said conditioner-fertilizer in liquid phase.

18. A method for restoring the cultivation properties of saline or alkaline soils, comprising applying to said soils a conditioner-fertilizer according to claim 1, in an amount of about 3 to about 100 liters/ha.

19. A method for restoring the cultivation properties of saline or alkaline soils, comprising applying to said soils a conditioner-fertilizer according to claim 12, wherein said application of the conditioner-fertilizer is made directly to the soil for absorption by the radicular system of plants.

20. A method for restoring the cultivation properties of saline or alkaline soils, comprising applying a conditioner-fertilizer according to 12 to the leaves of plants growing in the soil.

21. A method for restoring the cultivation properties of saline or alkaline soil, comprising applying to the soil the conditioner-fertilizer according to claim 12, in an amount of about 1 to about 5 liters/ha.

22. A method for restoring the cultivation properties of saline or alkaline soils, comprising applying to said soils a conditioner-fertilizer according to claim 12, by means of a micro-irrigation system.

23. A method for restoring the cultivation properties of saline or alkaline soils, comprising applying to said soils in irrigation water a conditioner-fertilizer according to claim 12.

24. A method for improving the agricultural productivity of saline soils or alkaline soils, said method comprising applying to said soils or to plants growing therein a conditioner composition comprising
a) a soil chelating agent
b) a pH buffering agent, and
c) a surfactant.
